(19) United States
(12) Patent Application Publication
(10) Pub. No.: US 2013/0136279 A1
(43) Pub. Date: May 30, 2013

(54) Personal Listening Device

(71) Applicants: Jeremy A Brown, Halifax (CA); Robert B.A. Adamson, Halifax (CA); Manohar Bance, Halifax (CA)

(72) Inventors: Jeremy A Brown, Halifax (CA); Robert B.A. Adamson, Halifax (CA); Manohar Bance, Halifax (CA)

(21) Appl. No.: 13/814,942

(22) PCT Filed: Aug. 8, 2011
(86) PCT No.: PCT/US11/46879

§ 371 Date: Feb. 8, 2013

Related U.S. Application Data
(60) Provisional application No. 61/371,832, filed on Aug. 9, 2010.

(51) Int. Cl. H04R 1/10

(52) U.S. Cl. CPC H04R 1/10
USPC 381/151

(57) ABSTRACT

Among other things, an audio device for transmission of sound information to a user's pinna is disclosed, the device having an actuator and a rigid backing attached to the actuator so as to form a gap without walls between the actuator and the backing.

This application claims priority to U.S. Provisional Patent application Ser. No. 61/371,832, entitled “PERSONAL LISTENING DEVICE”, filed Aug. 9, 2010; the disclosure of which is hereby incorporated by reference in its entirety.

### BACKGROUND

Earphones provide sound to the user's ear while radiating minimal sound into the environment, creating a personal listening experience. Earphones can either fit snugly inside the ear canal against the tragus (earbuds) where they are held in place by friction or they may be held in place by a spring-like band that connects the two ears and runs on top of or behind the user's head. Earphones may also fit against or over the ears, again held in place with a band. The actuator element in an earphone typically delivers sound by using a magnetic driver driving a diaphragm made of plastic or other material that acts to pressurize the air. Air-borne pressure waves travel down the ear canal and vibrate the tympanic membrane resulting in the perception of hearing.

It is also known that the perception of hearing can be achieved by vibrating the skull bone, and some earphones take advantage of this effect. This “bone conduction” allows the ear canal to be left unoccluded so that the user's ability to hear ambient sounds such as traffic and conversation is not impeded. Bone conduction can provide increased safety and a listening experience closer in nature to listening to a distant loudspeaker sound source. Unfortunately bone conduction may filter the sound and may have difficulty delivering low frequencies.

An alternative known means of delivering sound while leaving the ear canal open is to vibrate the cartilage and soft tissues of the outer ear, at the pinna. The use of a vibrator attached to the earlobe to achieve this was disclosed in WO 2001/87007. WO 2005/025267 and WO 2008/145949 teach the use of a piezoelectric, cantilevered actuator that sits behind the ear, either encased in a soft material (WO 2005/025267) so as to form a cavity, or simply-supported on plastic or foam blocks (WO 2008/145949). WO 2002/30151 teaches the coupling of an audio apparatus to the pinna by means of a clip or a hook and the attachment of the apparatus to the rear of the pinna opposite the concha. WO 2005/025267 teaches a number of ways of mounting such a device on the ear including the use of two hooks, one hanging over the pinna and the other passing over the bottom of the pinna. WO 2008/145949 teaches that such a device may also be attached to eyeglasses.

### SUMMARY

In general, in an aspect, an audio device for transmission of sound information to a user's pinna has an actuator and a rigid backing attached to the actuator so as to form a gap without walls between the actuator and the backing. Implementations may include one or more of the following features. The backing has a top end and a bottom end. The actuator has a top end and a bottom end. The backing and actuator are attached near their respective top ends by a first simple support, and the backing and actuator are attached near their respective bottom ends by a second simple support. The first and the second simple supports are each fabricated of ABS plastic.

The backing has a top end and a bottom end, the actuator has a top end and a bottom end, the actuator has a first metallic vane originating from a first shim overhanging the top end and attaching to the top end of the backing, and the actuator has a second metallic vane originating from a second shim overhanging the bottom end and attaching to the bottom end of the backing. The actuator has a first layer of piezoelectric material and a second layer of piezoelectric material, the first shim interposes the first layer and the second layer, and the second shim is mounted overtop the second layer. The device includes a multiplicity of layers of piezoelectric material of approximately equal area and a multiplicity of shims of approximately equal length, with shims N interposing layers N and N+1 if present, in which each shim has a length exceeding that of the layers, each odd-numbered shim has an odd-numbered metallic vane overhanging the top end and attaching to the top end of the backing, and each even-numbered shim has an even-numbered metallic vane overhanging the bottom end and attaching to the bottom end of the backing. The odd-numbered vanes are bent so as to be connected to a common attachment point near the top end of the backing, and in which the even-numbered vanes are bent so as to be connected to a common attachment point near the bottom end of the backing. The common attachment point near the top end electrically and mechanically bonds the odd-numbered vanes together, and in which the common attachment point near the bottom end electrically and mechanically bonds the even-numbered vanes together.

The gap is partially defined by a distance between the actuator and the backing approximately wide enough so as to allow air to freely circulate, whereby the device acts as an acoustic dipole radiator. The device also includes a band having a first end and a second end, bonded near the first end to an anterior side of the backing and having a knob bonded near the second end and facing the posterior, the length of the band being sufficient to span a distance from the posterior of the pinna to the anterior of the conchal bowl. The second end has a clip contacting the external ear. The actuator is cantilevered and piezoelectric. The actuator is magnetostrictive.

In general, in an aspect, a piezoelectric multilayered actuator has a plurality of sandwiched layers of piezoelectric material and shim layers in which alternating shim layers extend past the piezoelectric layers on opposite sides Implementations may include one or more of the following features. The shim layers are electrically and mechanically connected near their extensions in two groups situated on opposite sides. The two groups of shim layers are bent approximately perpendicular to the layers of piezoelectric material. The two groups of shim layers are respectively attached to opposing ends of a rigid backing.

In general, in an aspect, an audio device for transmission of sound information to a user's tragus and ear canal includes a cantilever having a first end and a second end and having a length sufficient to reach from the tragus into the ear canal, the first end being mounted to an actuator comprising piezoelectric material Implementations may include one or more of the following features. The device also includes a retainer ring mounted to the second end.

In general, in an aspect, an audio device for transmission of sound information to a user's tragus includes a cantilever having a first end and a second end and having a length sufficient to reach around the tragus, the first end being mounted to an actuator and the second end being mounted to a clip.

These and other features and aspects, and combinations of them, may be expressed as methods, systems, components, means and steps for performing functions, apparatus, articles of manufacture, compositions of matter, and in other ways.

One advantage of aspects of the invention over presently available personal listening devices is that high-quality sound is provided without occluding the listener's ear canal, allowing the listener to also hear ambient sounds and conversation, improving safety and comfort and providing a listening experience akin to being in a room with a loudspeaker while still being able to hear other sounds in the environment.

Other advantages and features will become apparent from the following description and from the claims.

### DESCRIPTION

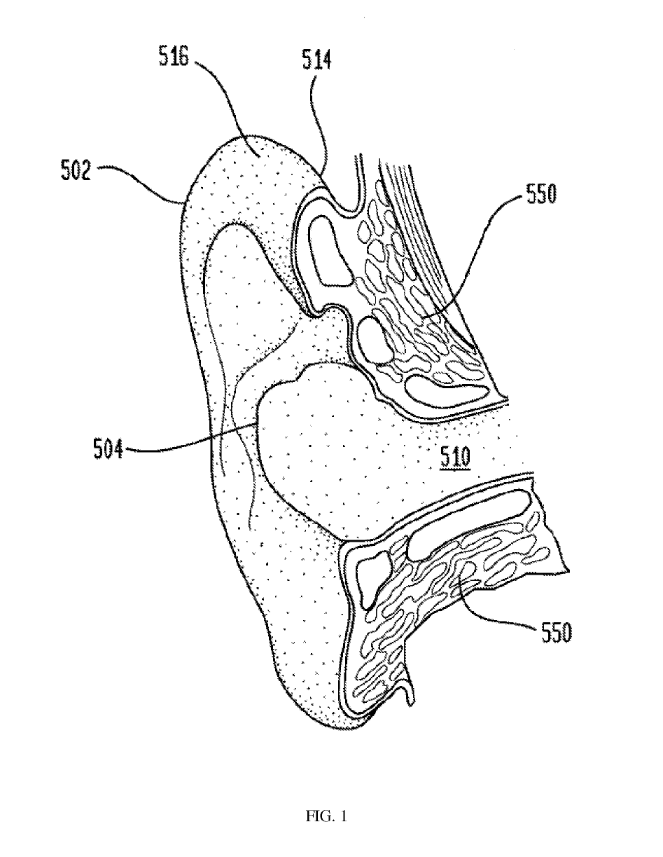

FIG. 1 shows a partial cross-sectional view of a human auditory system.

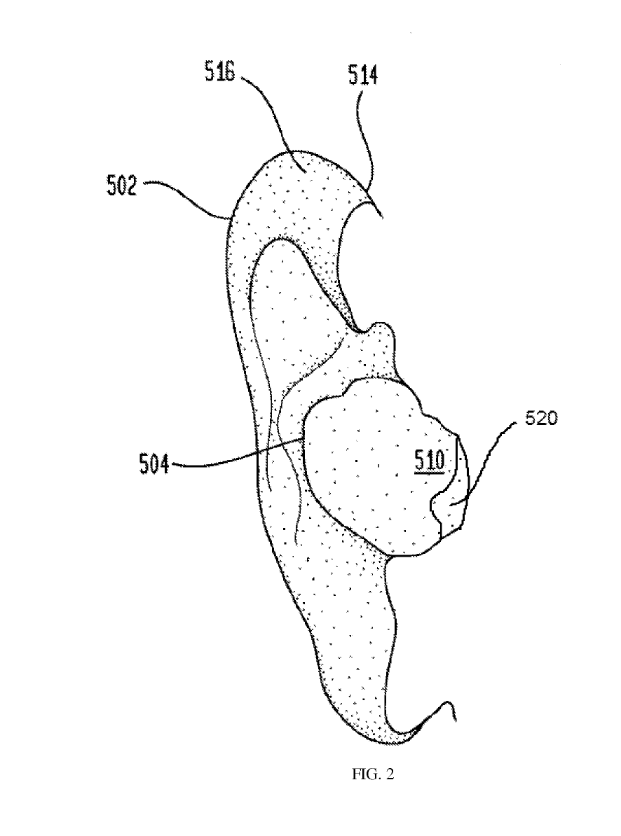

FIG. 2 shows a partial cross-sectional view of a human outer ear.

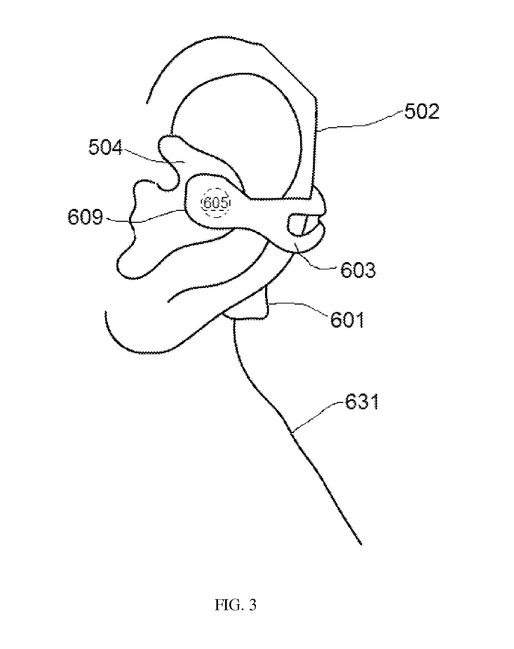

FIG. 3 shows an audio device for transmission of sound information to a user's pinna as viewed looking onto the anterior of the outer ear.

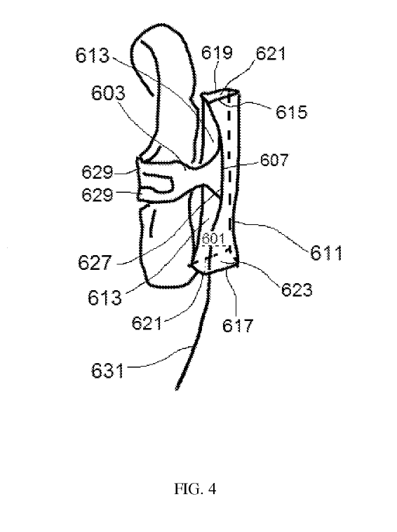

FIG. 4 shows an audio device for transmission of sound information to a user's pinna as viewed looking onto the posterior of the outer ear.

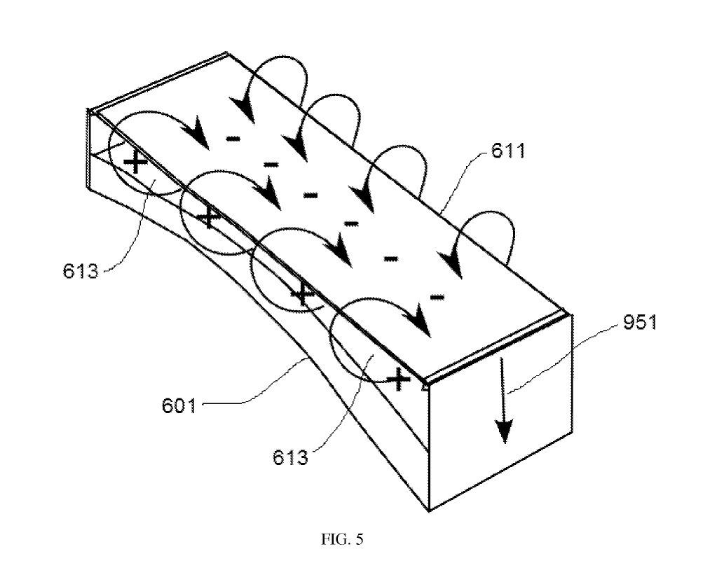

FIG. 5 illustrates the air flow (curved arrows) and pressure pattern (plus and minus symbols) around the gap between actuator and backing. The direction of motion for the center of the actuator 951 is depicted as a downward straight arrow.

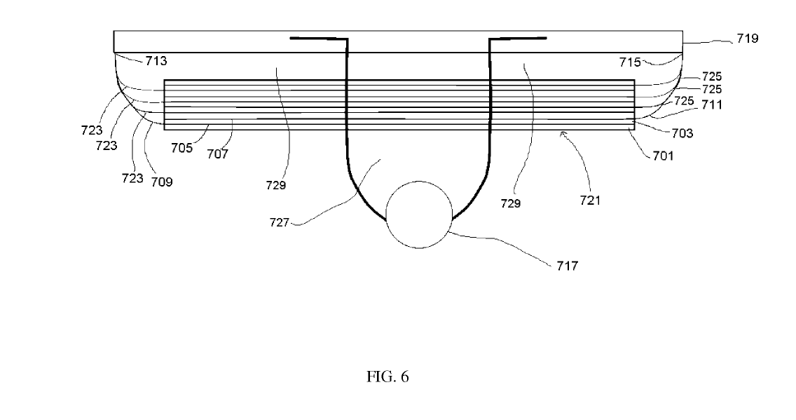

FIG. 6 shows an audio device with an actuator connected to a backing using metallic vanes.

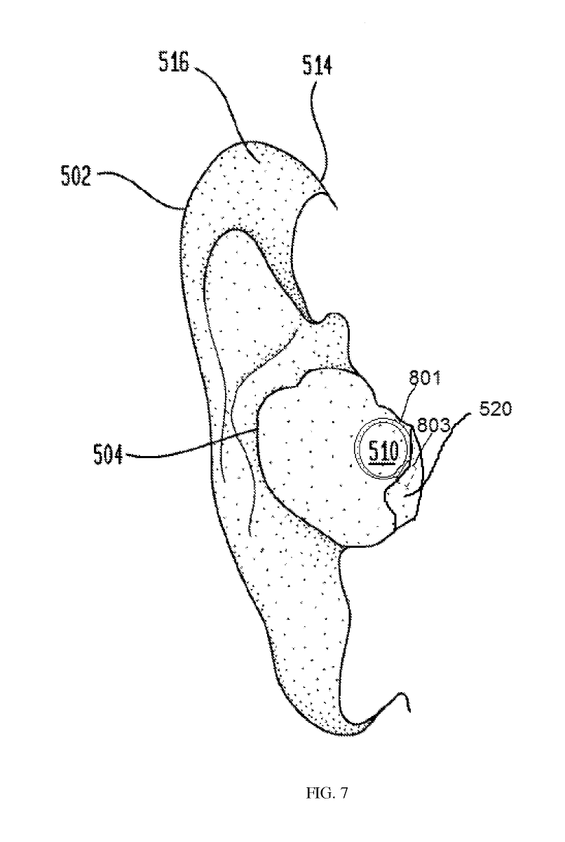

FIG. 7 illustrates a tragus vibrator contacting the posterior of the tragus and held in place with a semi-rigid, flexible retainer ring.

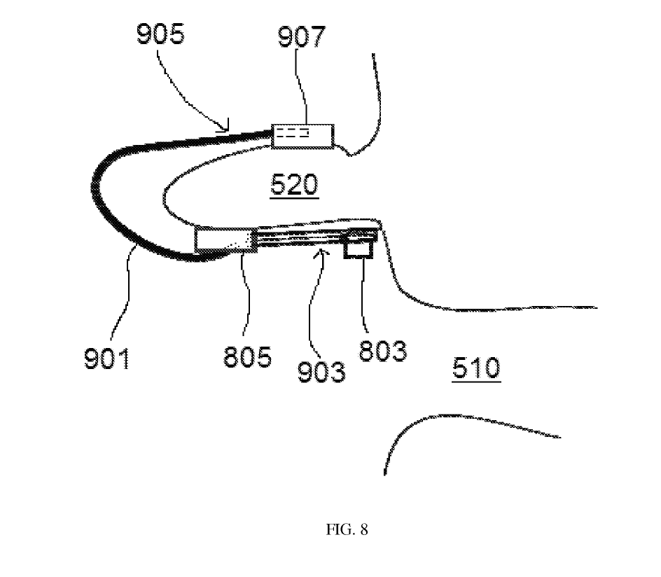

FIG. 8 illustrates a tragus vibrator with optional mass contacting the posterior of the tragus and held in place with a clip at the anterior of the tragus.

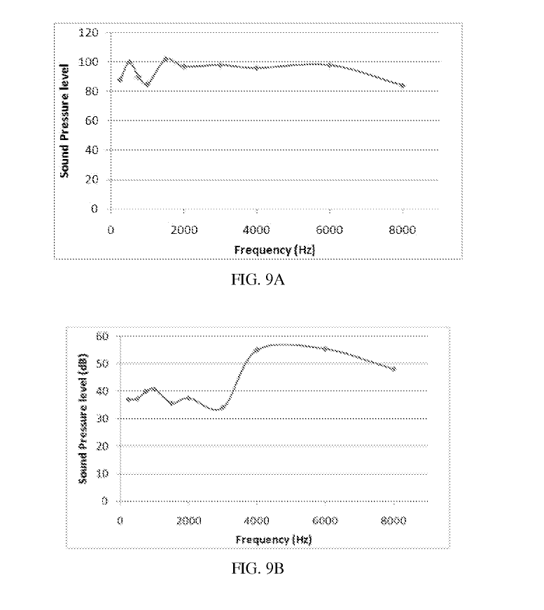

FIG. 9 shows sound pressure levels generated using a pinna-mounted bimorph actuator. FIG. 9A shows sound pressure levels measured in the ear canal. FIG. 9B shows sound pressure levels measured 6 inches (˜15 cm) from the ear canal.

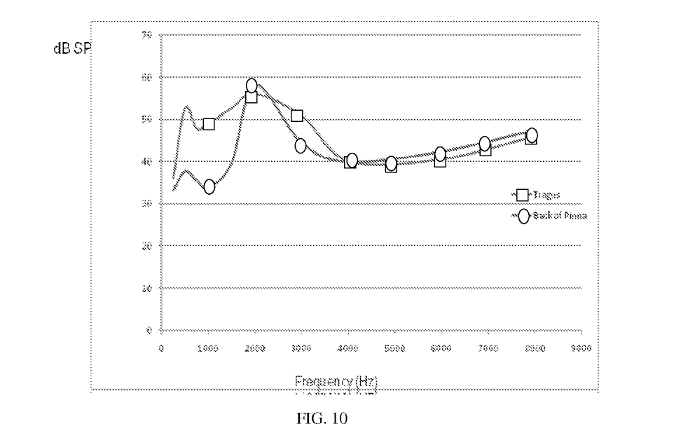

FIG. 10 shows sound pressure levels generated in the external ear canal using pinna-mounted and tragus-mounted actuators, measured using an ER-7 (Etymotics research) microphone in the ear canal in a single subject. Device was set for comfortable listening level, and not maximal output.

### FIGURE LEGEND

502 Pinna
504 Conchal bowl, anterior of the conchal bowl
510 Ear canal, entrance to ear canal
514 Posterior auricular surface, posterior of the pinna
516 Anterior auricular surface
520 Tragus
550 Cartilage and soft tissues
601 Actuator, piezoelectric cantilever
603 Band
605 Knob
607 First end of the band
609 Second end of the band
611 Rigid backing
613 Gap
615 Top end of the backing
617 Bottom end of the backing
619 Top end of the actuator
621 Bottom end of the actuator
623 First simple support
625 Second simple support
627 Anterior side of the backing
629 Clip
631 Audio cable, audio connector
701 First layer of piezoelectric material
703 Second layer of piezoelectric material
705 First shim, first shim layer
707 Second shim, second shim layer
709 First metallic vane
711 Second metallic vane
713 Common attachment point near the top end of the backing
715 Common attachment point near the bottom end of the backing
717 Knob
719 Backing
721 Piezoelectric multilayered actuator
723 Odd-numbered metallic vane
725 Even-numbered metallic vane
727 Band
729 Gap
801 Retainer ring
803 Vibrator, actuator
805 Mass
901 Cantilever
903 First end of the cantilever
905 Second end of the cantilever
907 Clip
951 Direction of motion for center of piezoelectric cantilever

Among other things, we describe herein a personal listening device having an actuator that transmits sound information by vibrating the soft tissue of the external ear. The external ear may include, for example, the pinna, the tragus, or the external ear canal. Vibrators can be placed on the pinna or the tragus, as both have cartilage extending into the external auditory canal which can create sound pressure in the external ear canal. The user's ability to hear ambient sounds such as traffic and conversation is not impeded. Moreover, the sound quality delivered by devices disclosed herein is comparable to that of conventional earphones. Some embodiments of the device act by vibrating the listener's pinna (the cartilaginous external ear), attaching to the pinna by means of a spring-like band that may run around the side of the ear or over the top of the ear. A knob at the end of the band may be made of a soft material like silicone or rubber and may fit comfortably into the listener's conchal bowl where it is held in place by the conchal bowl. The fact that it is cartilage vibrations and not simply air-borne sound that arrives at the user's eardrum may be seen by the fact that occluding the ear makes the device louder, particularly at low frequencies.

Some embodiments of the invention here disclosed have an actuator and a rigid backing attached to the actuator so as to form a gap. A gap is to be understood as a space without walls, bounded in one axis by the actuator-backing distance but otherwise generally unbounded. In particular, a gap may allow for the free flow of air between actuator and backing. When the distance between the actuator and the backing is approximately wide enough so as to allow air to freely circulate, the device may act as an acoustic dipole radiator, which reduces the amount of low frequency (long wavelength) acoustic radiation experienced by nearby people or animals while still providing low frequency acoustic radiation to the user.

One embodiment of the invention is depicted in FIGS. 3 and 4 with reference to anatomical features depicted in FIGS. 1 and 2, as follows. An audio device for transmission of sound information to a user's pinna 502 includes a band 603 with a first end 607 and a second end 609. To hold the piezoelectric actuator in place, a rigid backing 611 is attached behind it (on the other side from the pinna). The first end attaches to the anterior side 627 of the rigid backing 611 having a top end 615 and a bottom end 617, while the second end has a knob 605 facing in a posterior direction and held in place at the conchal bowl 609 by tension in the band 603. The rigid backing 611 is attached to an actuator 601 in such a way as to leave a gap 613 between backing and actuator. The actuator 601 in turn contacts the posterior of the pinna 502. The actuator has a top end 619 and a bottom end 621. An audio cable 631 connects the actuator to a signal source. Sound information is carried by electrical circuit through an audio connector to the actuator, which when in position upon the user's pinna 502, vibrates the cartilage and soft tissues 550 of the outer ear. In some embodiments, the band may be spring-like. In some embodiments, the band includes a clip 629 that follows the contours of the pinna from back to front. In some embodiments, the actuator may be a piezoelectric cantilever. In some embodiments, the top end 615 of the rigid backing 611 is attached near the top end 619 of the actuator 601 by a first simple support 623. In some embodiments, the bottom end 617 of the rigid backing 611 is attached near the bottom end 621 of the actuator 601 by a second simple support 625.

The actuator-backing distance may be approximately maintained in a number of ways. For example, in some embodiments, the distance may be approximately maintained by simple supports. In some embodiments, there are at least two simple supports, with one attaching to the backing at a point near the back of the device (defined, for clarity, as the direction nearest the user's head when worn) and one attaching to the backing at a point near the front of the device. In some embodiments, as in one of the Examples below, the simple support can be fabricated of a thin layer of ABS plastic and can act as a flexible support to the cantilevered actuator.

In some embodiments, the actuator in contact with the posterior side of the pinna is a piezoelectric cantilevered bending actuator. A piezoelectric cantilever actuator is a structure that bends when an electric field is applied to it. It consists of one or more piezoelectric layers which can be made of piezoceramic, piezopolymers or crystalline piezoelectrics. Actuators with one piezoelectric layer are called unimorphs, with two bimorphs and with more than two multimorphs. Between the piezoelectric layers may be metallic shims The piezoelectric layers may be poled so that the upper half of the structure expands laterally while lower half contracts, creating a bending moment in the whole structure. Increasing the number of layers increases the device capacitance and so lowers its electrical impedance. A low impedance is desirable because the output amplifiers in most personal listening devices have output impedances of 8 ohm or 16 ohm, and maximum output power is achieved when the device has the same impedance as the amplifier.

In some embodiments, the distance may be approximately maintained by supports including metallic vanes extending from shims inside the actuator; a vane or vanes originating from the top of the device would attach to a common point near the top of the device, while a vane or vanes originating from the bottom of the device would attach to a common point near the bottom of the device. One such embodiment is illustrated in FIG. 6. In some embodiments, a metallic vane 709, 723 may originate from a shim 705 overhanging the top end of the actuator. In some embodiments, a metallic vane 711, 725 may originate from a shim 707 overhanging the bottom end of the actuator. In some embodiments, the actuator 721 has layers of piezoelectric material 701, 703 that are interposed by shims 705, 707 which are longer than the length of the layers, and which have metallic vanes that alternately overhang the top end and the bottom end of the actuator; the vanes 709, 723 overhanging the top end may attach to the top end of the backing, and the vanes 711, 725 overhanging the bottom end may attach to the bottom end of the backing. In some embodiments, the vanes overhanging the top end may be bent so as to have a common point of attachment 713 to near the top end of the backing, and the vanes overhanging the bottom end may be bent so as to have a common point of attachment 715 to near the bottom end of the backing. In some embodiments, vanes attached to near the back of the device are further electrically connected to a positive terminal and vanes attached to near the front of the device are further electrically connected to a negative terminal. In some embodiments, vanes attached to near the back of the device are further electrically connected to a negative terminal and vanes attached to near the front of the device are further electrically connected to a positive terminal.

In some embodiments, the vanes are part of a multilayered piezoelectric actuator, with multiple piezoelectric layers and a thin metal shim separating each one. The metal and piezoelectric may be attached together with conductive epoxy, cyanoacrylate or any other adhesive or by other means. Shim layers may be alternately connected to the positive and negative terminals of the driving amplifier so that the direction of the electric field in alternate layers of piezoelectric is opposite. The piezoelectric layers may be poled so that those lying above the neutral plane (which lies at the transverse center for a symmetric structure) all expand while those below the neutral plane all contract (and vice versa). In some embodiments, all the shims of one polarity extend past the piezoelectric layers on one side and the shims of the other polarity all extend past the piezoelectric layer on the other side. The shims can then be bent down on the two sides, electrically connected together with conductive epoxy, solder or other means and attached together to the backing layer. This approach to manufacturing the actuators is physically robust since metal attachment occurs over a large surface area, it provides a convenient attachment point for wires, and it provides the vanes necessary to attach the backing layer to the actuator. In some embodiments, the shims are made of an electrically conductive foil such as, for example, copper, brass, or gold foil. In some embodiments, the shims may be between about 200 μm in thickness to about 10 μm in thickness; or 150 μm in thickness to 10 μm in thickness; or 100 μm in thickness to 10 μm in thickness; or 50 μm in thickness to 10 μm in thickness. In some embodiments, the shims may be between about 100 μm in thickness to about 25 μm in thickness. In some embodiments, the gap between actuator and backing is approximately rectilinear. In some embodiments, the area of the vanes may be large enough to provide support to the approximately maintain the gap but small enough to supply negligible impedance to air flow.

The extent to which the actuator-backing distance may be maintained and the range of values obtained for that distance in a given embodiment depends on a number of factors, including the strength of the supports, the flexibility of the supports, the relative rigidity of the backing, the magnitude and direction of vibration in the actuator when operating, and the nature and relative rigidity of the attachment. Other factors may also apply. The attachment of the supports may be accomplished using, for example, adhesive, epoxy, or solder; which material or combination of materials to use may depend on whether the point of attachment should also be electrically conductive.

In some embodiments, the actuator is held in close contact with the pinna by use of a band 603 that holds it near the pinna 502 under tension. Such a band may wrap from the back of the ear at the pinna 502 to the front of the ear near the conchal bowl 504, either spanning the side of the ear or from the top of the ear. In some embodiments, the band may be spring-like, attached on one end to the backing near the anterior 627 (i.e. at the point facing the same direction as the user's nose when worn), and may have a knob 605 bonded to the other end that faces the posterior; such a knob may then sit in the conchal bowl of a user's ear when the device is worn. In some embodiments, the band may be spring-like. In some embodiments, a spring-like band has a mechanism incorporating a hoop, whereby compressing the hoop vertically causes the band to open horizontally for removal of the device. In some embodiments, a spring-like band includes a bistable memory material which can be held in an open state (i.e., to remove the device from the user's ear) or a closed state (i.e., to secure the device to the user's pinna for listening). In some embodiments, a spring-like band has a mechanical latch attached between the ends that when closed can reduce the band's length such that the actuator is held near the pinna, and when open can maintain sufficient length to allow the user to remove the device. As can be seen from the foregoing, many other variations are possible. In some embodiments, there is a mechanism by which pressure applied vertically by the user's fingers is translated to a horizontal force that causes the spring-like band to open. In some embodiments, there is a locking spring comprised of memory steel that is bistable with an open and a closed position. In some embodiments, the band slips onto the pinna from the side and opens naturally when pressed over the cartilaginous ridge at the entrance to the conchal bowl.

In some embodiments, the band includes a simple attachment system that slips onto the pinna from the side; the conchal bowl knob is round so that by simply applying pressure to the actuator when the edge of the pinna is between the knob and the actuator, the shape of the knob will tend to open the spring-like band, and further pressure will force the knob over the cartilaginous ridge between the edge of the pinna and the conchal bowl, the shape of the knob being such that once it reaches the conchal bowl it will sit comfortably and securely in place.

In some embodiments, a spring-like band uses a vertically oriented hoop to open. When the listener presses on the two ends of the hoop vertically, the hoop will deform so as to become wider in the horizontal direction. This will tend to open up the spring-like band allowing easy insertion onto the pinna. The hoop may have various shapes including circle, oval and octagon, among other shapes. Any of these will perform the same function of transforming a vertical pinching motion into an opening motion of the spring-like band.

In some embodiments, a spring-like band is made from memory metal or other shape-memory material can allow the spring-like band to have two stable positions, one open and one closed. This functionality can also be achieved, among other ways, with a latching mechanism and a spring. To place the actuator on the pinna the spring-like band is stretched to the open position, moved into place and snapped close. Because for small deformation memory materials behave elastically, they will maintain the static pressure necessary to maintain contact with the pinna. A spring, among other things, can achieve the same effect in a latching mechanism.

In some embodiments, the actuator may be cantilevered with respect to the backing, allowing it to move freely, for example, along the pinna. In some embodiments, the actuator comprises piezoelectric material. In some embodiments, the actuator is a piezoelectric actuator In some embodiments, the actuator comprises magnetostrictive material. In some embodiments, the actuator includes a unimorphic piezoelectric. In some embodiments, the actuator includes a bimorphic piezoelectric. In some embodiments, the actuator includes a multimorphic piezoelectric. In some embodiments, the multimorph piezoelectric bending actuator has conductive vanes that extend out laterally past the piezoelectric layers. These vanes are connected together electrically and wrapped onto the backing material, forming a robust mechanical attachment point both to the actuator and to the backing and providing a convenient location for attachment of electrical connections.

In some embodiments, the actuator may include a mass 805 for improved low-frequency response. The resonance frequency of the device is set by the bending stiffness of the actuator and by its mass. The attachment of a mass 805 to the center of the actuator tends to lower the resonance frequency and improve the low frequency response of the device. Some embodiments of the present invention incorporate this feature. In some embodiments, the mass 805 has a mass is less than about 5 grams; or less than about 3 grams; or less than about 1 gram. In some embodiments, the mass 805 has mass between about 1 gram and about 3 grams. In some embodiments, the mass 805 is approximately 5mm by 5mm by 2mm in size, though the size may vary depending on a variety of factors, including the size of the actuator, the bending stiffness of the actuator, and the mass of the mass 805, among other factors. In some embodiments, the mass 805 may include highly dense material. In some embodiments, the mass 805 comprises tungsten. In some embodiments, the mass 805 comprises tungsten-loaded epoxy.

In some embodiments incorporating a piezoelectric cantilevered actuator, a piezoelectric transformer may be electrically connected to the actuator. In some embodiments, the transformer may be incorporated into the rigid backing and electrically connected inline to the actuator by way of common points of attachment in the backing (e.g., via the metallic vanes discussed above). In some embodiments, the transformer may be incorporated into audio equipment external to the device (e.g., an audio “headphone” jack or some other jack) and electrically connected inline by way of the audio connector 631. Piezoelectric transformers of the kind discussed above may be useful for, among other things, increasing the voltage applied to a piezoelectric cantilevered actuator, thus potentially reducing the number of layers required to obtain the desired sound quality.

In some embodiments, the transformer is a Rosen-type piezoelectric transformer; in such a transformer, an RF signal centered at the transformer resonance frequency is applied, creating acoustic waves in the piezoelectric transformer. The resulting high-voltage signal is rectified, low-pass filtered and applied to the piezoelectric cantilevered bending actuator. In some embodiments, the transformer is constructed as depicted in U.S. Provisional Application Ser. No. 61/371,832, FIG. 5, which is incorporated by reference. While a multilayered actuator can achieve good impedance-matching with an 8-ohm or 16-ohm audio output driver, in some embodiments a magnetic or piezoelectric transformer is incorporated like the one described by Rosen in U.S. Pat. No. 5,751,092 (hereby incorporated by reference) into the body of the device either at the electrical plug in the case of a magnetic transformer or as part of the actuator backing in the case of the piezoelectric transformer. In the case of the piezoelectric transformer, a radio-frequency signal close to the resonance frequency of the transformer is required. This signal would be generated by the external driving circuitry and modulated with the desired acoustic signal. A piezoelectric transformer may increase the voltage of the signal which is then demodulated by rectifying diodes or other rectifying circuits and filtered to apply a large voltage across the actuator. This allows the actuator to be made thicker or out of fewer layers which will reduce the cost of the device.

When a voltage is applied to a piezoelectric cantilever, its center deflects either towards the ear part to be vibrated (e.g. the pinna or tragus) or towards the gap. In the former case this creates positively pressurized air anterior to the ear part and negatively pressurized air in the gap, and in the latter case negatively pressurized air anterior to the ear part and positively pressurized air in the gap. This is illustrated in FIG. 5. In either case the pressure difference between the anterior side of the ear part and the gap will tend to drive air flow in such a way as to cancel the pressure difference. At low frequencies, the acoustic cycle may be long enough that sufficient air can flow so as to effectively equalize the pressure difference. As a result, far from the device there may be very little measurable pressure change. At high frequencies pressure equalization may become less effective because there is less time in each cycle for the air to flow. This radiative behavior is characteristic of a dipole acoustic radiator, which is enabled by the presence of a gap without walls, of sufficient actuator-backing distance so as to allow air flow. A dipole radiator can be thought of as a set of two monopole radiators driving air out of phase and separated by some distance d. If each of those monopole radiators has an integrated air flow volume velocity Q, then far from the dipole radiator the radiated intensity is given by

$$I ( r ) = \frac{1}{4} ρ {c ( \frac{Q}{λ r} )}^{2} {( \frac{2 π d}{λ} )}^{2}$$

where c is the speed of sound in air, r is the distance from a pole center to the measurement point, ρ is the air density, and λ is the acoustic wavelength.

In cases where air may not able to flow effectively into the gap, such as in cases where the gap is enclosed by walls (i.e., forming a sealed cavity) or the actuator-backing distance is small enough to impede air flow, the radiative behavior would be more characteristic of a monopole radiator. As an example, personal listening devices known in the art that include a piezoelectric cantilevered pinna actuator (e.g. WO2008/145949, hereby incorporated by reference) feature a sealed cavity between actuator and backing. The cavities in such devices would tend to act like a soft spring, absorbing the pressure applied by the cantilever. A point monopole radiator with an integrated air flow volume velocity of Q is produces an intensity distribution as a function of distance r from the center given by

$$I ( r ) = \frac{1}{8} ρ {c ( \frac{Q}{λ r} )}^{2}$$

where c is the speed of sound in air, r is the distance from a pole center to the measurement point, ρ is the air density, and λ is the acoustic wavelength.

Since the intensity of the radiated sound is proportional to 1/λ⁴ in a dipole radiator versus 1/λ² in a monopole radiator, the amount of low frequency (long wavelength) acoustic radiation experienced at a distance from the user is significantly reduced for a dipole radiator as opposed to a monopole radiator.

Personal listening devices described herein may act like a dipole radiator so long as the air gap between the backing layer and the actuator is sufficiently large so as to present a small impedance to air flow compared to the impedance presented to radiation. An appropriate size for the gap can be determined experimentally by measuring the amount of radiated sound from a device with a given actuator-backing distance while it is being worn by a test subject. Repeated experiments with devices of various actuator-backing distances can produce a value for the optimal gap size for a predetermined application, type of sound information, genre, user, or user group, among other factors.

The tragus is generally comprised of cartilage covered by skin and soft tissue. The tragus is the most deeply penetrating cartilage into the ear canal, and is separate from the pinna. In some embodiments utilizing conduction at the pinna, when an actuator is placed adjacent to a user's pinna, sound information is transmitted by vibrating the cartilage and soft tissues of the outer ear, at the pinna. In some embodiments utilizing conduction at the tragus, when an actuator is placed adjacent to a user's tragus, sound information is transmitted by vibrating the cartilage and soft tissues of the outer ear, at the tragus. In some embodiments, a vibrating device may be located on the tragus, the small flap of cartilage on the anterior side of the ear. To do this, a piezoelectric cantilevered bender actuator is placed inside of the ear canal and one end of the cantilever is attached to a spring-like clip that applies pressure between the anterior and posterior sides of the tragus. The other end of the cantilever protrudes into the ear canal and is free to vibrate. This end may have a mass attached to it to reduce resonance frequency and increase force into the tragus. The cartilage of the tragus may be vibrated by the reactive force of the clip end of the piezoelectric cantilever. This vibration may be transmitted along the cartilage of the ear canal and eventually received by the inner ear.

In some embodiments, such as those shown in FIGS. 7 and 8, the actuator 803 is held in close contact with the tragus 520. Induced tragus vibrations are likely to differ for a given input than pinna vibrations, as the cartilage at the tragus may be much less thick than the conchal bowl, has different soft tissue thickness, and is not connected by soft tissue to the lateral surface of the bony mastoid. In some embodiments, a personal listening device may be used by patients who have skin conditions such as psoriasis affecting the pinna portion of the ear, or who wish to wear other devices such as blue-tooth or other audio adaptors around the pinna. In some embodiments, an actuator for vibrating the tragus may sit either on the lateral (outer) surface of the tragus, or on its inner surface; either position would serve to generate sound pressure in the ear canal by using the tragus as a cartilaginous diaphragm to vibrate the air column at the entrance to the ear canal, and inside the ear canal. In some embodiments, the actuator 803 may be mounted near the end 903 of a cantilever 901, the length of which may be sufficient to enter the ear canal 510; it does not have to penetrate deeply into the canal. In some embodiments, the end 905 of the cantilever 901 that is not mounted to the actuator may have a retainer ring 801 installed, such that the ring is braced against the entrance to the ear canal 510 and the actuator 803 is held near the tragus by static pressure or friction. Cartilage vibration may be optimized to have as large a vibration surface as possible within the confines of the ear canal, and impedance matched to the cartilage rather than the bony ear canal. In some embodiments, the actuator may be relatively flat. In some embodiments, the actuator may be curved somewhat to follow the shape of the ear anatomy to be contacted. In some embodiments, the actuator may be a mechanical vibration transducer adapted to be mounted near the tragus, of size not more than 1 cm in both medio-lateral and superior-inferior directions so as not to impinge on the sensitive and thin skin of the bony ear canal. In some embodiments, the retainer ring is semi-flexible. In some embodiments, the retainer ring is rubberized. In some embodiments, the retainer ring is a silicone material. In some embodiments, the retainer ring is metal. In some embodiments, the retainer ring is deformable to allow for greater comfort or contact against the tragus. In some embodiments, the retainer ring is held in place by the posterior aspect being placed in the conchal bowl as it curves to the antihelical fold. In some embodiments, the end of the cantilever that is not mounted to the actuator may have a clip 907 installed, such that the actuator is held near the tragus when the clip is attached to the opposite side of the tragus. In some embodiments, the actuator is a piezoelectric cantilevered bending actuator which vibrates the tragus and transmits sound to the ear canal via cartilage. In some embodiments, the clip 907 holds the actuator upon the external surface of the tragus. In some embodiments, the clips holds the actuator against the inner surface of the tragus. Which side of the tragus provides better performance depends on a number of factors, including the degree to which a user's tragus is asymmetric. In some embodiments, the cantilever has a mass attached.

### EXAMPLES

### Example 1

### Testing of a Pinna Vibrating Personal Listening Device

A pinna-driving audio device was tested on a subject for radiated sound and induced sound pressure level as a means of comparing it to other earphones. The backing and spring were made of ABS plastic and the conchal bowl knob of soft silicone. A piezoelectric bimorph was attached between two simple supports made of thin ABS plastic. Tones of the same level were recorded as MP3 files and played through an Apple iPod Nano 4G. A small electromagnetic transformer was connected inline with the connector to boost the voltage applied to the piezo. An Etymotics ER7 earphone measured the sound pressure level inside the ear canal. A Bruel and Kjaer Type 2250 omnidirectional sound level meter measured the sound level 6 inches outside and directly lateral to the ear canal. The results are shown in FIG. 9. The ear canal pressure from the device exceeded 95 dB SPL over a 200-8000 Hz range except for a notch at 1000 Hz. Frequencies below 4000 Hz were prevented from radiating outward to bystanders by the dipole radiator effect introduced by the gap between the piezoelectric cantilever and the backing layer.

### Example 2

### Testing of a Tragus Vibrating Personal Listening Device

We have shown that a vibrator placed on the tragus is able to generate sound pressure levels similar, or better, to those obtained by a vibrator placed on the back of the pinna by measuring the sound pressure level induced using a small piezoelectric cantilever vibrator placed with static pressure of about 1 N using a static spring load, and running a frequency sweep generated with Labview® code. Sound pressure levels in the external ear canal were measured using an ER-7 Etymotics (Elk Grove, Ill.) microphone to measure the resulting sound pressure levels. The results are shown in FIG. 10.

### Example 3

### Demonstration of Dipole Radiator Aspects of Personal Listening Device

An embodiment of a pinna-driving audio device as in Example 1 was tested on a subject for determination of dipole radiator aspects. The baseline amount of radiated acoustic intensity is established with the device operating normally. At each frequency considered the electrical signal delivered to the device was set to achieve a 75 dB SPL in the ear canal of the subject user. The acoustic intensity was then measured at a distance of 1.0 m laterally from the user's ear at a distance of 3″ (about 7.6 cm) to maximize signal level and to minimize the influence of reflected sound. The device was then sealed, adding walls to the gap to form a cavity, which may make it act as an acoustic monopole. Measurements were taken in this configuration also. Results are reported in the table below:

| Frequency | Ear Canal | 3″ (dB SPL) | | |
|---|---|---|---|---|
| (Hz) | (dB SPL) | Open | Sealed | Δ |
| 250 | 75.0 | 16.9 | 18.8 | 1.9 |
| 500 | 75.1 | 28.0 | 34.9 | 6.9 |
| 1000 | 75.0 | 25.1 | 47.6 | 22.5 |
| 2000 | 75.0 | 44.0 | 52.8 | 8.9 |
| 3000 | 75.0 | 28.3 | 35.0 | 6.7 |
| 4000 | 75.0 | 43.4 | 54.9 | 11.5 |
| 6000 | 75.0 | 55.3 | 56.8 | 1.5 |
| 8000 | 75.0 | 36.1 | 38.8 | 2.7 |
| Average | 75.0 | 34.6 | 42.5 | 7.8 |

As expected from acoustic theory and the above equations, the measurements show a decrease in free field radiated sound when the device operates normally (open) as opposed to when sealed. This result is consistent with the device acting as an acoustic dipole and the sealed device acting as an acoustic monopole. The result also suggests that personal listening devices that lack this dipole radiative aspect produce more sound in the vicinity of bystanders: as much as about 22.5 dB, according to the above table, and about 8 dB on average across frequencies tested.

### Example 4

### Measurement of Effect of a Knob Contacting the Conchal Bowl

An embodiment of a pinna-driving audio device as in Example 1 was tested on a subject for determination of acoustic effects somewhat attributable to the presence of a conchal bowl contact pad, such as a knob. For this Example, the actuator (piezoelectric element) was in contact with the back (posterior) of the ear and the clip was in contact with the outer portion of the pinna (i.e. the scapha and anti-tragus). Using the input voltages known to produce 75 dB SPL in the ear canal with the contact pad in place, the contact pad was removed and ear canal pressure measurements were repeated. Results are shown in the following table:

| Frequency | Signal | Ear Canal (dB SPL) | | |
|---|---|---|---|---|
| (Hz) | (Vₚₚ) | Pad | No Pad | Δ |
| 250 | 670 | 75.0 | 69.8 | −5.1 |
| 500 | 390 | 75.1 | 68.6 | −6.5 |
| 1000 | 770 | 75.0 | 66.8 | −8.1 |
| 2000 | 800 | 75.0 | 70.4 | −4.6 |
| 3000 | 290 | 75.0 | 69.8 | −5.1 |
| 4000 | 390 | 75.0 | 76.1 | 1.2 |
| 6000 | 1770 | 75.0 | 75.4 | 0.5 |
| 8000 | 346 | 75.0 | 65.6 | −9.4 |
| Average | | 75.0 | 70.3 | −4.7 |

Results show an average increase of approximately 5 dB SPL in the ear canal when using the conchal bowl contact pad, suggesting that sound information may be more efficiently transmitted when the contact pad (e.g. a knob) is in contact with the conchal bowl.

1. An audio device for transmission of sound information to a user's pinna, the device comprising an actuator and a rigid backing attached to the actuator so as to form a gap without walls between the actuator and the backing.

2. The device of claim 1 in which the backing has a top end and a bottom end, the actuator has a top end and a bottom end, the backing and actuator are attached near their respective top ends by a first simple support, and the backing and actuator are attached near their respective bottom ends by a second simple support.

3. The device of claim 2 in which the first and the second simple supports are each fabricated of ABS plastic.

4. The device of claim 1 in which the backing has a top end and a bottom end, the actuator has a top end and a bottom end, the actuator has a first metallic vane originating from a first shim overhanging the top end and attaching to the top end of the backing, and the actuator has a second metallic vane originating from a second shim overhanging the bottom end and attaching to the bottom end of the backing.

5. The device of claim 4 in which the actuator has a first layer of piezoelectric material and a second layer of piezoelectric material, the first shim interposes the first layer and the second layer, and the second shim is mounted overtop the second layer.

6. The device of claim 5 in which there are a multiplicity of layers of piezoelectric material of approximately equal area and a multiplicity of shims of approximately equal length, with shims N interposing layers N and N+1 if present, in which each shim has a length exceeding that of the layers, each odd-numbered shim has an odd-numbered metallic vane overhanging the top end and attaching to the top end of the backing, and each even-numbered shim has an even-numbered metallic vane overhanging the bottom end and attaching to the bottom end of the backing.

7. The device of claim 6 in which the odd-numbered vanes are bent so as to be connected to a common attachment point near the top end of the backing, and in which the even-numbered vanes are bent so as to be connected to a common attachment point near the bottom end of the backing.

8. The device of claim 7 in which the common attachment point near the top end electrically and mechanically bonds the odd-numbered vanes together, and in which the common attachment point near the bottom end electrically and mechanically bonds the even-numbered vanes together.

9. The device of claim 1 in which the gap is partially defined by a distance between the actuator and the backing approximately wide enough so as to allow air to freely circulate, whereby the device acts as an acoustic dipole radiator.

10. The device of claim 1 further comprising a band having a first end and a second end, bonded near the first end to an anterior side of the backing and having a knob bonded near the second end and facing the posterior, the length of the band being sufficient to span a distance from the posterior of the pinna to the anterior of the conchal bowl.

11. The device of claim 10 in which the second end has a clip contacting the external ear.

12. The device of claim 1 in which the actuator is cantilevered and piezoelectric.

13. The device of claim 1 in which the actuator is magnetostrictive.

14. A piezoelectric multilayered actuator comprising a plurality of sandwiched layers of piezoelectric material and shim layers in which alternating shim layers extend past the piezoelectric layers on opposite sides.

15. The actuator of claim 14 in which the shim layers are electrically and mechanically connected near their extensions in two groups situated on opposite sides.

16. The actuator of claim 15 in which the two groups of shim layers are bent approximately perpendicular to the layers of piezoelectric material.

17. The actuator of claim 16 in which the two groups of shim layers are respectively attached to opposing ends of a rigid backing.

18. An audio device for transmission of sound information to a user's tragus and ear canal, the device comprising a cantilever having a first end and a second end and having a length sufficient to reach from the tragus into the ear canal, the first end being mounted to an actuator comprising piezoelectric material.

19. The audio device of claim 18 further comprising a retainer ring mounted to the second end.

20. An audio device for transmission of sound information to a user's tragus, the device comprising a cantilever having a first end and a second end and having a length sufficient to reach around the tragus, the first end being mounted to an actuator and the second end being mounted to a clip.
